(19) United States
(12) Patent Application Publication
(10) Pub. No.: US 2026/0247452 A1
(43) Pub. Date: Aug. 20, 2026

(54) RANDOM ACCESS CHANNEL PREAMBLE TECHNIQUES

(71) Applicant: QUALCOMM Incorporated, San Diego, CA (US)

(72) Inventors: Sitaramanjaneyulu KANAMARLAPUDI, San Diego, CA (US); Umesh PHUYAL, San Diego, CA (US); Mostafa KHOSHNEVISAN, San Diego, CA (US)

(21) Appl. No.: 19/054,598

(22) Filed: Feb. 14, 2025

(51) Int. Cl. H04W 74/0833; H04W 72/12; H04W 74/08

(52) U.S. Cl. CPC H04W 74/085; H04W 72/12; H04W 74/0875

(57) ABSTRACT

Methods, systems, and devices for wireless communications are described. A user equipment (UE) may perform a random access procedure with a network entity for multiple purposes, such as initial access, cell handover, in response to scheduling request failure, in response to radio link failure, or a small data transmission. A UE may transmit two random access channel (RACH) preambles within a same RACH occasion (RO), and transmission of the second preamble may indicate additional information associated with the UE. For example, the additional information may enable the network entity to prioritize between UEs that use the same preamble sequence in the same RO. For example, such additional information may indicate a UE type, a RACH procedure establishment cause, or a priority level of a communication that that the UE intends to transmit.

### FIELD OF TECHNOLOGY

The following relates to wireless communications, including random access channel preamble techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, within a random access channel (RACH) occasion, a first preamble that uses a first sequence from a set of multiple candidate sequences, transmitting, within the RACH occasion and after transmission of the first preamble, a second preamble that is based on the first sequence, where the second preamble is indicative of an identifier associated with the UE, and receiving a response message based on the first preamble and the second preamble.

A UE for wireless communications is described. The UE may include one or more memories storing processor executable code, and one or more processors coupled with the one or more memories. The one or more processors may individually or collectively be operable to execute the code to cause the UE to transmit, within a RACH occasion, a first preamble that uses a first sequence from a set of multiple candidate sequences, transmit, within the RACH occasion and after transmission of the first preamble, a second preamble that is based on the first sequence, where the second preamble is indicative of an identifier associated with the UE, and receive a response message based on the first preamble and the second preamble.

Another UE for wireless communications is described. The UE may include means for transmitting, within a RACH occasion, a first preamble that uses a first sequence from a set of multiple candidate sequences, means for transmitting, within the RACH occasion and after transmission of the first preamble, a second preamble that is based on the first sequence, where the second preamble is indicative of an identifier associated with the UE, and means for receiving a response message based on the first preamble and the second preamble.

A non-transitory computer-readable medium storing code for wireless communications is described. The code may include instructions executable by one or more processors to transmit, within a RACH occasion, a first preamble that uses a first sequence from a set of multiple candidate sequences, transmit, within the RACH occasion and after transmission of the first preamble, a second preamble that is based on the first sequence, where the second preamble is indicative of an identifier associated with the UE, and receive a response message based on the first preamble and the second preamble.

In some examples of the method, UEs, and non-transitory computer-readable medium described herein, the second preamble may be based on the first sequence via using a second sequence that may be an XOR operation of the first sequence and the identifier.

In some examples of the method, UEs, and non-transitory computer-readable medium described herein, the second preamble may be indicative of the identifier of the UE based on a duration between transmission of the first preamble and the second preamble.

In some examples of the method, UEs, and non-transitory computer-readable medium described herein, the second preamble uses the first sequence.

In some examples of the method, UEs, and non-transitory computer-readable medium described herein, the identifier may be indicative of a RACH establishment cause associated with the first preamble and the second preamble.

In some examples of the method, UEs, and non-transitory computer-readable medium described herein, the identifier may be indicative of a device type of the UE.

In some examples of the method, UEs, and non-transitory computer-readable medium described herein, the identifier may be indicative of a priority associated with the UE.

In some examples of the method, UEs, and non-transitory computer-readable medium described herein, a duration between transmission of the first preamble and the second preamble may be based on a RACH occasion periodicity, a cell dimension associated with the RACH occasion, or a combination thereof.

Some examples of the method, UEs, and non-transitory computer-readable medium described herein may further include operations, features, means, or instructions for receiving system information that indicates a duration between subsequent preambles within a same RACH occasion, where transmission of the second preamble may be in accordance with the duration.

Some examples of the method, UEs, and non-transitory computer-readable medium described herein may further include operations, features, means, or instructions for receiving control signaling addressed to the UE that indicates a duration between subsequent preambles within a same RACH occasion, where transmission of the second preamble may be in accordance with the duration.

Some examples of the method, UEs, and non-transitory computer-readable medium described herein may further include operations, features, means, or instructions for transmitting a third preamble in a second RACH occasion after the RACH occasion in accordance with backoff information indicated in the response message.

Some examples of the method, UEs, and non-transitory computer-readable medium described herein may further include operations, features, means, or instructions for transmitting a RACH message in a resource indicated in a grant provided by the response message.

A method for wireless communications by a network entity is described. The method may include receiving, from a UE and within a RACH occasion, a first preamble that uses a first sequence from a set of multiple candidate sequences, receiving, from the UE and within the RACH occasion and after transmission of the first preamble, a second preamble that is based on the first sequence, where the second preamble is indicative of an identifier associated with the UE, and transmitting, to the UE, a response message based on the first preamble and the second preamble.

A network entity for wireless communications is described. The network entity may include one or more memories storing processor executable code, and one or more processors coupled with the one or more memories. The one or more processors may individually or collectively be operable to execute the code to cause the network entity to receive, from a UE and within a RACH occasion, a first preamble that uses a first sequence from a set of multiple candidate sequences, receive, from the UE and within the RACH occasion and after transmission of the first preamble, a second preamble that is based on the first sequence, where the second preamble is indicative of an identifier associated with the UE, and transmit, to the UE, a response message based on the first preamble and the second preamble.

Another network entity for wireless communications is described. The network entity may include means for receiving, from a UE and within a RACH occasion, a first preamble that uses a first sequence from a set of multiple candidate sequences, means for receiving, from the UE and within the RACH occasion and after transmission of the first preamble, a second preamble that is based on the first sequence, where the second preamble is indicative of an identifier associated with the UE, and means for transmitting, to the UE, a response message based on the first preamble and the second preamble.

A non-transitory computer-readable medium storing code for wireless communications is described. The code may include instructions executable by one or more processors to receive, from a UE and within a RACH occasion, a first preamble that uses a first sequence from a set of multiple candidate sequences, receive, from the UE and within the RACH occasion and after transmission of the first preamble, a second preamble that is based on the first sequence, where the second preamble is indicative of an identifier associated with the UE, and transmit, to the UE, a response message based on the first preamble and the second preamble.

In some examples of the method, network entities, and non-transitory computer-readable medium described herein, the second preamble may be based on the first sequence via using a second sequence that may be an XOR operation of the first sequence and the identifier.

Some examples of the method, network entities, and non-transitory computer-readable medium described herein may further include operations, features, means, or instructions for performing an XOR operation on the first sequence and the second sequence to extract the identifier from the second sequence.

In some examples of the method, network entities, and non-transitory computer-readable medium described herein, the second preamble may be indicative of the identifier of the UE based on a duration between transmission of the first preamble and the second preamble.

In some examples of the method, network entities, and non-transitory computer-readable medium described herein, the second preamble uses the first sequence.

In some examples of the method, network entities, and non-transitory computer-readable medium described herein, the identifier may be indicative of a RACH establishment cause associated with the first preamble and the second preamble.

In some examples of the method, network entities, and non-transitory computer-readable medium described herein, the identifier may be indicative of a device type of the UE.

In some examples of the method, network entities, and non-transitory computer-readable medium described herein, the identifier may be indicative of a priority associated with the UE.

In some examples of the method, network entities, and non-transitory computer-readable medium described herein, a duration between transmission of the first preamble and the second preamble may be based on a RACH occasion periodicity, a cell dimension associated with the RACH occasion, or a combination thereof.

Some examples of the method, network entities, and non-transitory computer-readable medium described herein may further include operations, features, means, or instructions for transmitting system information that indicates a duration between subsequent preambles within a same RACH occasion, where reception of the second preamble may be in accordance with the duration.

Some examples of the method, network entities, and non-transitory computer-readable medium described herein may further include operations, features, means, or instructions for transmitting control signaling addressed to the UE that indicates a duration between subsequent preambles within a same RACH occasion, where reception of the second preamble may be in accordance with the duration.

Some examples of the method, network entities, and non-transitory computer-readable medium described herein may further include operations, features, means, or instructions for receiving a third preamble in a second RACH occasion after the RACH occasion in accordance with backoff information indicated in the response message.

Some examples of the method, network entities, and non-transitory computer-readable medium described herein may further include operations, features, means, or instructions for receiving, from a second UE and within the RACH occasion, a third preamble that uses the first sequence, receiving, from the second UE and within the RACH occasion, a fourth preamble that may be based on the first sequence, where the second preamble may be indicative of a second identifier associated with the second UE, and transmitting, to the second UE, a grant that indicates a resource for a random access message based on the identifier and the second identifier, where inclusion of the backoff information in the response message may be based on the identifier and the second identifier.

Some examples of the method, network entities, and non-transitory computer-readable medium described herein may further include operations, features, means, or instructions for receiving, from the UE, a RACH message in a resource indicated in a grant provided by the response message.

Some examples of the method, network entities, and non-transitory computer-readable medium described herein may further include operations, features, means, or instructions for receiving, from a second UE and within the RACH occasion, a third preamble that uses the first sequence and receiving, from the second UE and within the RACH occasion, a fourth preamble that may be based on the first sequence, where the second preamble may be indicative of a second identifier associated with the second UE, where inclusion of the grant in the response message may be based on the identifier and the second identifier.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access channel (RACH) preamble techniques in accordance with one or more aspects of the present disclosure.

FIG. 2 shows an example of a timing diagram and a preamble sequence correlation-time graph that support RACH preamble techniques in accordance with one or more aspects of the present disclosure.

FIG. 3 shows an example of a wireless communications system that supports RACH preamble techniques in accordance with one or more aspects of the present disclosure.

FIG. 4 shows an example of a timing diagram that supports RACH preamble techniques in accordance with one or more aspects of the present disclosure.

FIG. 5 shows an example of a process flow that supports RACH preamble techniques in accordance with one or more aspects of the present disclosure.

FIGS. 6 and 7 show block diagrams of devices that support RACH preamble techniques in accordance with one or more aspects of the present disclosure.

FIG. 8 shows a block diagram of a communications manager that supports RACH preamble techniques in accordance with one or more aspects of the present disclosure.

FIG. 9 shows a diagram of a system including a device that supports RACH preamble techniques in accordance with one or more aspects of the present disclosure.

FIGS. 10 and 11 show block diagrams of devices that support RACH preamble techniques in accordance with one or more aspects of the present disclosure.

FIG. 12 shows a block diagram of a communications manager that supports RACH preamble techniques in accordance with one or more aspects of the present disclosure.

FIG. 13 shows a diagram of a system including a device that supports RACH preamble techniques in accordance with one or more aspects of the present disclosure.

FIGS. 14 and 15 show flowcharts illustrating methods that support RACH preamble techniques in accordance with one or more aspects of the present disclosure.

### DETAILED DESCRIPTION

In wireless communications systems, a user equipment (UE) may perform a random access procedure with a network entity for multiple purposes, such as initial access, cell handover, in response to scheduling request failure, in response to a radio link failure, to transition to cell connected mode from an idle or inactive mode, or to perform a small data transmission (SDT). To initiate the random access procedure, the UE may transmit a random access preamble to the network entity in a random access channel (RACH) occasion (RO). ROs may be indicated and/or mapped to synchronization signal blocks (SSBs). A random access preamble may use a Zadoff-Chu (ZC) sequence. The autocorrelation and cross-correlation properties of ZC sequences may enable a network entity to distinguish UEs that transmit preambles in the same resource and estimate the timing advance per UE based on the relative position of the UE with respect to the network entity. Before transmitting a random access preamble, the UE may accordingly select a sequence from a set of candidate sequences (e.g., the quantity of candidate sequences may depend on the length of the sequence). In response to a random access preamble, a network entity may transmit a MSG2 which may provide a grant for a MSG3. The UE may indicate in MSG3 the establishment cause for the RACH procedure (e.g., the purpose of the RACH procedure) and/or a UE identifier, which may indicate a type of UE. In the case that multiple UEs select a same sequence in the same RO, the network entity may be unable to distinguish the purpose, and thus the priority, and/or the type of UE until MSG3. Accordingly, the network entity may be unable to provide a backoff indication to UEs associated with lower priority type RACH procedures until after reception of MSG3.

In some aspects, a UE may transmit two RACH preambles within a same RO, and transmission of the second preamble may indicate additional information associated with the UE. For example, the additional information may enable the network entity to prioritize between UEs that use the same preamble sequence in the same RO. For example, such additional information may indicate a UE type, a RACH procedure establishment cause, or a priority level of a communication that that the UE intends to transmit. In some examples, the first preamble and the second preamble may use the same sequence, and the duration between the first preamble and the second preamble may implicitly indicate the additional information. For example, a one slot duration may indicate a first establishment cause and a two slot duration may indicate a second establishment cause. As another example, based on the cross-correlation properties of ZC sequences, the sequence of the second preamble may be generated via an XOR operation of the first sequence and the additional information, which may enable the network entity to extract the additional information from the second sequence and correlate the first preamble and the second preamble as being received from the same UE. Accordingly, the network entity may prioritize RACH requests from different UEs at the preamble stage of the RACH procedure, which may reduce congestion and collisions.

Aspects of the disclosure are initially described in the context of wireless communications systems. Aspects of the disclosure are further illustrated by and described with reference to timing diagrams, process flows, apparatus diagrams, system diagrams, and flowcharts that relate to RACH preamble techniques.

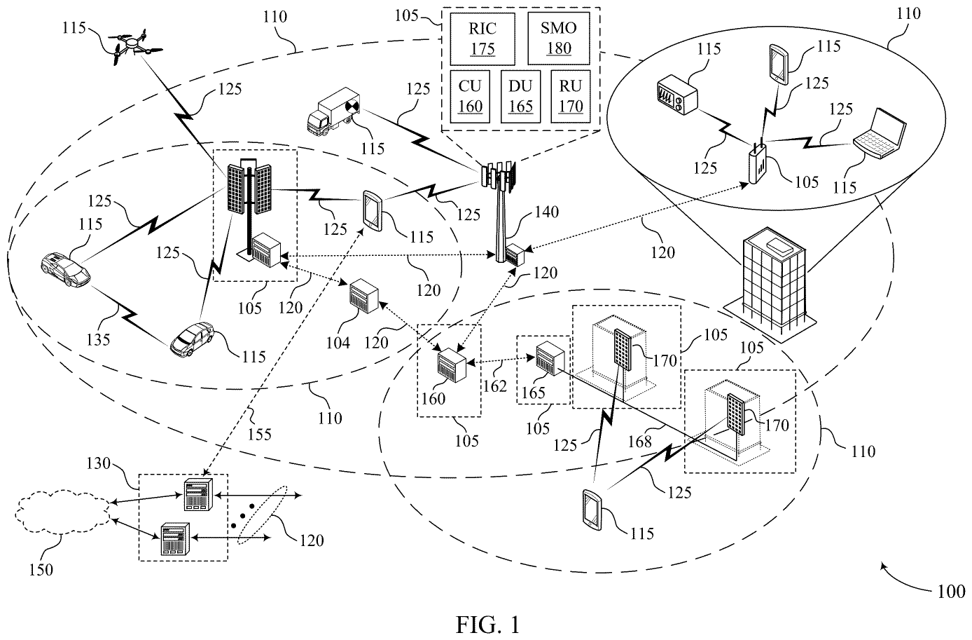

FIG. 1 shows an example of a wireless communications system 100 that supports RACH preamble techniques in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support RACH preamble techniques as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information (SI)), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

UEs 115 in the wireless communications system 100 may perform a RACH procedure with a network entity 105 for multiple purposes as described herein. To initiate a RACH procedure, a UE 115 may transmit a random access preamble to the network entity 105 in an RO. As described herein, in some aspects, a UE 115 may transmit two RACH preambles within a same RO, and transmission of the second preamble may indicate additional information associated with the UE 115. For example, the additional information may enable the network entity 105 to prioritize between UEs 115 that use the same preamble sequence in the same RO. For example, such additional information may indicate a UE 115 type, a RACH procedure establishment cause, or a priority level of a communication that that the UE 115 intends to transmit.

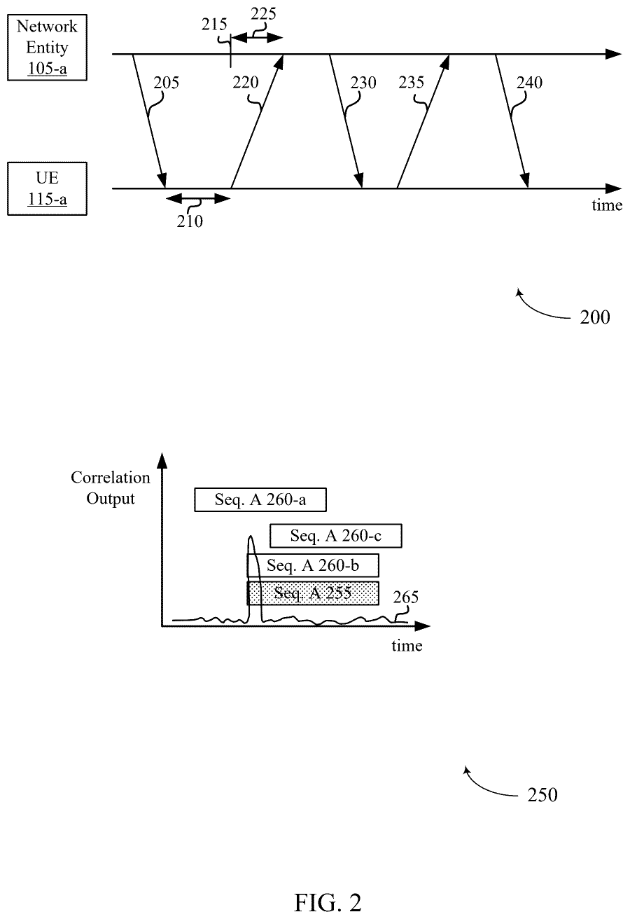

FIG. 2 shows an example of a timing diagram 200 and a preamble sequence correlation-time graph 250 that support RACH preamble techniques in accordance with one or more aspects of the present disclosure. The timing diagram 200 and the preamble sequence correlation-time graph 250 may implement or may be implemented by aspects of the wireless communications system 100. For example, FIG. 2 includes a UE 115-a, which may be an example of a UE 115 as described herein. FIG. 2 also includes a network entity 105-a, which may be an example of a network entity 105 as described herein.

As described herein, the UE 115-a may initiate a RACH procedure with the network entity 105-a via transmission of a RACH preamble, which may be conveyed as a MSG1 220 in an RO. ROs may be indicated and/or mapped to SSBs. For example, the network entity 105-a may transmit an SSB 205, and an RO for transmission of the MSG1 220 may be a time offset 210 after the SSB 205. For example, the RO may begin at a slot boundary 215 after the time offset 210. For example, SSB to RO mapping and timing information may be indicated in SI (e.g., which may be conveyed in a master information block (MIB) in the SSB 205 or other SI blocks (SIBs)).

The RACH preamble of the MSG1 220 may use a ZC sequence. ZC sequences may be complex sequences with a unit amplitude and a particular phase. In addition to RACH preambles, ZC sequences may also be used for multiple functions in cellular communications, such as downlink synchronization in initial access (e.g., in synchronization signals in SSBs), uplink control information (UCI) in physical uplink control channel (PUCCH) transmissions, uplink channel sounding for channel estimation, and reference symbols for channel estimation. ZC sequences may include two parameters used to construct a particular sequence: 1) the root index q=1, 2, . . . , N_{ZC}-1; and 2) the length of the sequence N_{ZC} which may be an odd number (and in some examples a prime number). For a sequence length N_{ZC}, there may be N_{ZC}-1 candidate sequences. A cyclic shift may refer to a rotation of a finite length sequence, and a sequence of length N may have N unique possible cyclic shifts. ZC sequences may have autocorrelation and cross-correlation characteristics that may be used for RACH procedures. When N_{ZC} is a prime number, a ZC sequence may have a constant amplitude, meaning that all values of the ZC sequence may have a constant amplitude with phase changes across samples, which may be useful in implementations from a peak to average power (PAPR) perspective. When N_{ZC} is a prime number, a ZC sequence may have zero cyclic autocorrelation, meaning that the autocorrelation results in zero values for all non-zero shifts of the ZC sequence. When N_{ZC} is a prime number, a ZC sequence may have a fixed cyclic cross-correlation, meaning that the cross-correlation may result in sqrt(N_{ZC}) when two distinct sequences of the same length but having been generated from different root index are cross-correlated, which may be an optimal cross-correlation property for sequences with optimal autocorrelation. When N_{ZC} is a prime number, ZC sequences may be directly generated in the frequency domain without generating the DFT of the sequence.

ZC sequences may be generated by extending or truncating a ZC of a length where N_{ZC} is a prime number to any other sequence length (e.g., when N_{ZC} is not a prime number). Such sequences generated by extending or truncating a ZC sequence where N_{ZC} is a prime number (such that the sequence length is not a prime number) may have less optimal cross-correlation and autocorrelation sequences as compared to a sequence where N_{ZC} is a prime number. In LTE and NR, resource blocks may be based on 12 subcarriers, and accordingly length 12 ZC sequences (e.g., where N_{ZC}=12) may be used in LTE and NR. For example, in LTE and NR length 12 ZC sequences may be used for uplink control channels and uplink demodulation reference signal (DMRS) symbols. Length 12 ZC sequences may be created via cyclic extension of ZC sequences where N_{ZC}=11.

As described herein, ZC sequences may be used for fundamental procedures in cellular communication. For example, for initial downlink synchronization, the primary synchronization signal (PSS) in an SSB (such as the SSB 205) may be based on N_{ZC}=63, and values q=29, 34, 25 may be used (based on respective autocorrelation and cross-correlation properties). PUCCH may be used to transmit CSI and acknowledgements and negative acknowledgment feedback for data communications. As multiple UEs 115 may share the same PUCCH, which may be used periodically, ZC sequences may be used to separate UEs on the same PUCCH. As another example, ZC sequences may be included in uplink reference signals to enable the network entity 105-a to perform channel estimation and timing synchronization (e.g., which may be demanded for effective demodulation performance of uplink data). For example, ZC sequences may be used for sounding reference signals (SRSs), which may be sent periodically when a UE 115 is not transmitting data. N_{ZC}=31 sequences may be cyclically extended in the frequency domain to achieve length 36 sequences for SRSs. ZC sequences may also be used in DMRS, which may be embedded with data transmission to aid in precise channel estimation.

In random access procedures (e.g., for the MSG1 220 or a MSGA), N_{ZC}=869 may be used for a long preamble and N_{ZC}=139 may be used for a short preamble in LTE and NR. As there may be no timing alignment for the uplink transmission of MSG1 or the MSGA, and as multiple UEs 115 may simultaneously access the network in a same RO, ZC sequence autocorrelation and cross-correlation characteristics may be used to distinguish UEs 115 and estimate the timing advance demanded per UE 115 based on relative position with the network entity 105-a.

A RACH procedure at the UE 115-a may include a preamble transmission, reception of a response (e.g., the MSG2 230), adjusting the uplink timing to achieve synchronization with the network entity 105-a, and an initial message transmission for network access. RACH procedures may include contention based procedures (e.g., where multiple UEs 115 contend for the same RO) and contention free procedures (e.g., where a given UE 115 may be assigned an RO). RACH procedures may include 4-step procedures (as shown in the timing diagram 200) and 2-step procedures (e.g., which may involve transmission of a MSGA by the UE 115 and transmission of a MSGB by the network entity 105). As described herein, the preamble length may be long (e.g., where N_{ZC}=869) or short (e.g., where N_{ZC}=139), for example, based on the cell size. For example, long preambles may be used for large cell sizes (e.g., 14 kilometers to 57 kilometers) and short preambles may be used for small cell sizes (e.g., 1 kilometers to 9 kilometers).

Timing related parameters for a RACH procedure may include the RO, which may be the time (e.g., the subframe, slot, and/or symbol) at which the network entity 105-a expects to receive the RACH preamble, and the response time window (e.g., a maximum time window in which the network entity 105-a is expected to send a response to a RACH preamble, such as the MSG2 230).

For example, the UE 115-a may transmit the MSG1 220 in an RO, and the network entity 105-b may receive the MSG1 220 a duration 225 after the slot boundary 215 of the RO. For example, the duration 225 may indicate the timing advance the network entity 105-a may calculate the UE 115-a should apply. The network entity 105-a may transmit the MSG2 230 within a duration expected by the UE 115-a. The MSG2 230 may indicate the timing advance for the UE 115-a to apply that the network entity 105-a may calculate based on the duration 225. The UE 115-a may transmit a MSG3 235 using the timing advance information included in the MSG2 230. For example, the MSG3 235 may convey an RRC connection request and may include a temporary cell radio network temporary identifier (TC-RNTI) for the UE 115-a. The MSG2 230 may indicate the TC-RNTI for the UE 115-a. The network entity 105-a may transmit a MSG4 240 in response to the MSG 3 235. For example, the MSG4 240 may be a contention resolution message for the UE 115-a, and may indicate a cell RNTI for the UE 115-a if the RACH procedure is successful for the UE 115-a (e.g., if the UE 115-a wins the contention) or may indicate a backoff duration after which the UE 115-a may reattempt the RACH procedure if the RACH procedure is not successful for the UE 115-a (e.g., if the UE 115-a loses the contention).

As shown in the preamble sequence correlation-time graph 250, the UE 115-a may use ZC preamble sequence A 255 in the MSG1 220. The network entity 105-a may use the autocorrelation characteristics of the ZC preamble sequence A 255 to determine the actual timing adjustment demanded to align the time of the UE 115-a with the network entity 105-a. For example, the line 265 shows the autocorrelation calculated by the network entity 105-a between the ZC preamble sequence A 255 received in the MSG1 220 and the same ZC preamble sequence 260 at other times. For example, as shown in the preamble sequence correlation-time graph 250, the autocorrelation output of the ZC preamble sequence A 255 received in the MSG1 220 and the ZC preamble sequence 260-a at an earlier time is low, the autocorrelation output of the ZC preamble sequence A 255 received in the MSG1 220 and the ZC preamble sequence 260-c at a later time is low, and the autocorrelation output of the ZC preamble sequence A 255 received in the MSG1 220 and the ZC preamble sequence 260-b at the same time is high. Accordingly, the network entity 105-a may identify the timing of the ZC preamble sequence A 255 received in the MSG1 220 by determining a peak in the autocorrelation output, which timing may be used to determine the timing advance indicated in the MSG2 230.

RACH procedures may be used for various signaling and data procedures, such as initial access, cell handover, scheduling request failures, radio link failure recovery, small data transmissions, lower layer triggered mobility (LTM) cell switching, or early synchronization in LTM. For example, different UEs 115 may initiate RACH procedures in the same RO for different purposes. In some examples, preambles may be exclusively partitioned for various features or verticals (e.g., LTM, small data transmission, reduced capability (RedCap) UEs). For example, in some configurations (such as early UL Sync procedure), preambles may be exclusively partitioned to identify the “user and source network entity 105 combination” such that the target network entity may measure the timing advance and identify the network entity based on preamble used to inform timing advance. As there are a limited quantity of RACH preambles (e.g., based on the sequence length N_{ZC}), dividing the RACH preambles per feature or vertical (e.g., LTM, SDT, RedCap) may limit the flexibility of preamble selection by reducing the quantity of preambles to select from for any particular feature or vertical, which may lead to more preamble collisions.

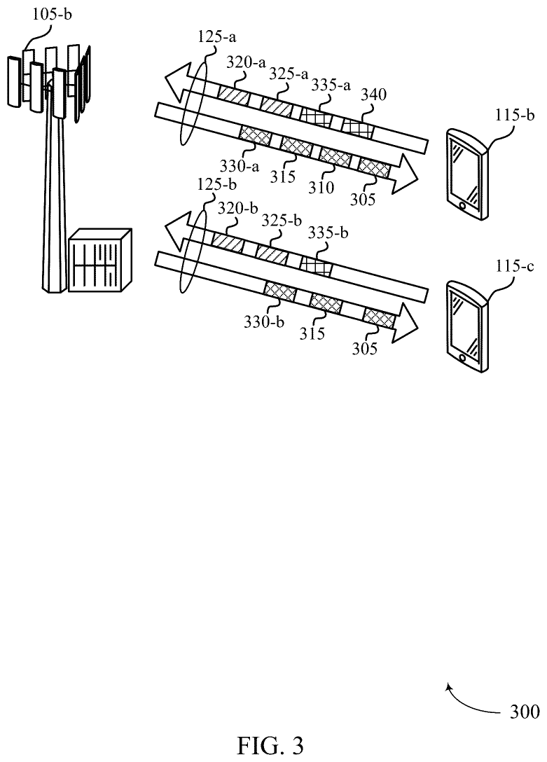

In a 4-step RACH procedure, MSG3 (e.g., MSG3 235 as described with reference to FIG. 3) may include an establishment cause information element (IE), which may indicate the purpose for the UE 115 initiating the RACH procedure. For example, establishment causes that may be indicated by the establishment cause IE may include: emergency, highPriorityAccess; mt (mobile terminal)-access, mo (mobile)-Data; mo-VoiceCall; mo-VideoCall; mo-SMS; multimedia priority service (mps)-PriorityAccess; and mission critical services (mcs)-PriorityAccess. Such purposes/establishment causes may be associated with different priority levels. Such purposes/establishment causes may enable the network entity 105 to distinguish between different priorities of access, which the network may use for contention resolution at step 4 of the 4-step RACH procedure. For example, MSG4 (e.g., a MSG4 240 as described with reference to FIG. 2) may include a backoff indicator which may indicate a duration of time for a UE which receives the MSG4 to delay before reattempting the RACH procedure. The network entity 105 may perform contention resolution (e.g., select which UE(s) 115 to allow to access the network and to which UE(s) to provide a backoff indication) based on the establishment causes.

FIG. 3 shows an example of a wireless communications system 300 that supports RACH preamble techniques in accordance with one or more aspects of the present disclosure. The wireless communications system 300 may implement or may be implemented by aspects of the wireless communications system 100, the timing diagram 200, or the preamble sequence correlation-time graph 250. For example, the wireless communications system 300 may include a UE 115-b and a UE 115-c, which may be an example of a UE 115 as described herein. The wireless communications system 300 may include a network entity 105-b, which may be an example of a network entity 105 as described herein.

The UE 115-b may communicate with the network entity 105-b using a communication link 125-a, and the UE 115-c may communicate with the network entity 105-b using a communication link 125-b. The communication link 125-a may be an example of an NR or LTE link between the UE 115-b and the network entity 105-b, and the communication link 125-b may be an example of an NR or LTE link between the UE 115-c and the network entity 105-b. The communication link 125-a and the communication link 125-b may include bi-directional links that enable both uplink and downlink communications. For example, the UE 115-b may transmit uplink signals (e.g., uplink transmissions), such as uplink control signals or uplink data signals, to the network entity 105-b using the communication link 125-a and the network entity 1050-b may transmit downlink signals (e.g., downlink transmissions), such as downlink control signals or downlink data signals, to the UE 115-b using the communication link 125-a. Similarly, the UE 115-c may transmit uplink signals (e.g., uplink transmissions), such as uplink control signals or uplink data signals, to the network entity 105-b using the communication link 125-b and the network entity 105-b may transmit downlink signals (e.g., downlink transmissions), such as downlink control signals or downlink data signals, to the UE 115-c using the communication link 125-b.

The network entity 105-b may transmit one or more SSBs 315. ROs may be mapped to SSBs 315 as described herein. For example, the UE 115-b may select an RO to initiate a RACH procedure (via transmission of a preamble sequence) based on measurements of SSBs 315. As an example, the UE 115-b may select an RO that is mapped to an SSB 315 which the UE 115-b determined satisfied a reference signal received power (RSRP) threshold. Similarly, the UE 115-c may may select an RO to initiate a RACH procedure (via transmission of a preamble sequence) based on measurements of SSBs 315.

The UE 115-b and the UE 115-c may implement techniques to provide additional information in the RACH preambles (e.g., at the MSG1 level) in order to enable the network entity 105-b to prioritize between UEs 115 at the MSG2 level. For example, the additional information in the RACH preambles may be establishment cause information, which may enable the network entity 105-b to reject lower priority establishment causes at the MSG2 level with a backoff indication. Such additional information may reduce collisions and congestion of ROs, which may be beneficial for loaded cells or radio resource management (RRM) policy oriented scheduling.

In some examples, the techniques to provide additional information in the RACH preambles may involve transmitting multiple RACH preambles within an RO. For example, the UE 115-b may transmit, within a given RO, a first preamble 320-a that uses a first sequence (e.g., a ZC sequence having a given N_{ZC}) from a set of multiple candidate sequences (e.g., the candidate ZC sequences of length N_{ZC}). Within the same RO and after the first preamble 320-a, the UE 115-b may transmit a second preamble 325-a based on the first sequence. The second preamble 325-a may be indicative of an identifier associated with the UE 115-b. The UE 115-b may receive a random access response message 330-a (e.g., a MSG2) based on the first preamble 320-a and the second preamble 325-a.

The second preamble 325-a may be transmitted a time delta T with respect to the first preamble 320-a. In some examples, the time delta T may be based on the density of configured ROs (e.g., the time between subsequent ROs). In some examples, the time delta T may be based on the cell dimensions (e.g., the physical size of the cell served by the network entity 105-b, such as in kilometers). In some examples, the time delta T may be predefined or standardized (e.g., based on a deployment configuration of such as the carrier frequency). In some examples, the network entity 105-b may indicate the time delta T in a SIB 305 (e.g., the time delta T may be indicated per cell). In some examples, the time delta T may be configured dynamically for the UE 115-b via a control message 310 such as via an RRC message or a MAC control element (MAC-CE). In some examples, the time delta T may be used to indirectly indicate the identifier of the UE 115-b. For example, a time delta T of one slot may indicate a first identifier, a time delta T of two slots may indicate a second identifier, and a time delta T of three slots may indicate a third identifier. In some examples, where the time delta T may be used to indirectly indicate the identifier of the UE 115-b, the second preamble 325-a may use the first sequence (e.g., may use the same ZC sequence as the first preamble 320-a).

In some examples, the second preamble 325-a may be combined with the identifier of the UE 115-b and the first sequence. For example, the sequence of the second preamble 325-a may be generated via an XOR operation of the identifier and the first sequence. For example, if ZC sequence A is used for the first preamble 320-a, the sequence of the second preamble 325-a may be given by (A XOR (A XOR X1)), where X1 is the identifier of the UE 115-b.

In examples where the sequence of the second preamble 325-a is generated via an XOR operation of the first sequence of the first preamble 320-a with the identifier of the UE 115-b, the network entity 105-b may decode the first preamble 320-a. The network entity 105-b may expect the second preamble 325-a at the time delta T with respect to the first preamble 320-a. When the network entity 105-b performs autocorrelation between the first preamble 320-a and the second preamble 325-a, instead of an autocorrelation of “1,” the output may be a value other than “0” where a value of “0” indicates perfect cross-correlation). The output of the autocorrelation between the first preamble 320-a and the second preamble 325-a may be interpreted according to (A XOR (A XOR X1))=X1. Accordingly, the network entity 105-b may extract the identifier of the UE 115-b from the autocorrelation output of the first preamble 320-a and the second preamble 325-a.

The identifier of the UE 115-b may be correlated to a RACH cause type (e.g., an establishment cause) or sub-classification within a vertical. In some examples, the identifier of the UE 115-b may indicate a UE type of the UE 115-b. For example, the identifier may indicate the UE is a RedCap UE, or may indicate a sub-class within RedCap or SDT. As another example, the identifier of the UE 115-b may distinguish between LTM types (e.g., inter-CU or intra-CU). As another example, the identifier may be used to multiplex UEs within primary preamble groups. For example, as described herein, RACH preambles may be divided per feature/vertical, and the identifier may be used to multiplex UEs within such features/verticals.

In some examples, the identifier may indicate vertical specific information (e.g., RedCap versus SDT). In some examples, the identifier may indicate feature specific information/establishment cause information (e.g., an mo-call versus an mt-call versus initial attachment). In some examples, the identifier may indicate priority information (e.g., emergency, high-priority, regular priority). In some examples, the identifier may indicate a combination of vertical specific information, feature specific information, and/or priority information (e.g., a high priority RedCap request).

In some examples, the UE 115-b and the UE 115-c may transmit, within the same RO, preambles that use the same sequence. For example, the UE 115-c may transmit, within the same RO that the UE 115-b transmits the first preamble 320-a, a first preamble 320-b that uses the first sequence (e.g., the same ZC sequence as the first preamble 320-a). Within the same RO and after the first preamble 320-b, the UE 115-c may transmit a second preamble 325-b based on the first sequence. The second preamble 325-b may be indicative of an identifier associated with the UE 115-c. The UE 115-c may receive a random access response message 330-b (e.g., a MSG2) based on the first preamble 320-b and the second preamble 325-b.

Accordingly, the network entity 105-b may have more information about the purposes of the RACH procedures associated with the preambles transmitted by the UE 115-b and the UE 115-c. For example, the network entity 105-b may send respective random access response messages 330 that either grant a resource for a MSG3 335 or provides a backoff indication. For example, if the network entity 105-b prioritizes the UE 115-c over the UE 115-b based on the respective identifiers indicated by the preambles 320 and 325, the network entity 105-b may provide a grant for a resource for a MSG3 in the random access response message 330-b and the network entity 105-b may provide a backoff indication to the UE 115-b in the random access response message 330-a. Accordingly, the UE 115-c may transmit a MSG3 335-b in accordance with the grant in the random access response message 330-b, and the UE 115-b may send another preamble 340 to initiate another RACH procedure after a period of time in accordance with the backoff indication in the random access response message 330-a. As another example, if there is no conflict or if the network entity 105-b prioritizes the UE 115-b, the random access response message 330-a may provide a grant for a MSG3, and the UE 115-b may transmit the MSG3 335-a in accordance with the grant in the random access response message 330-a.

In some examples, the network entity 105-b may provide different levels and/or types of grants in the random access response messages 330, for example, to avoid multi-step approaches to send actual data. For example, higher priority grants, grants indicating resources in a different BWP than was used for the preambles, or different scheduling patterns for the MSG3s may be used.

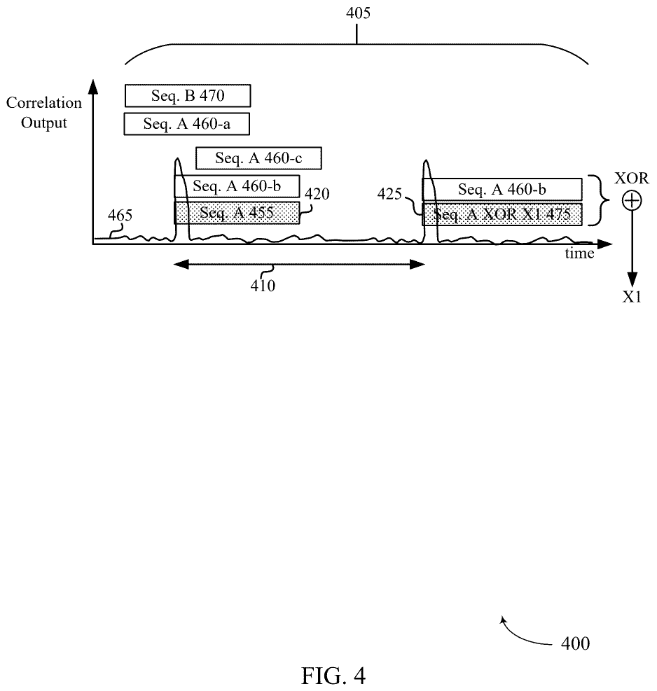

FIG. 4 shows an example of a preamble sequence correlation-time graph 400 that supports RACH preamble techniques in accordance with one or more aspects of the present disclosure. The preamble sequence correlation-time graph 400 may implement or may be implemented by aspects of the wireless communications system 100, the timing diagram 200, the preamble sequence correlation-time graph 250, or the wireless communications system 300.

As described herein, within an RO 405, a UE 115 may transmit two preambles, a first preamble 420 and a second preamble 425. The first preamble 420 may use a first ZC sequence (e.g., ZC preamble sequence A 455). The network entity 105 may use the autocorrelation characteristics of the ZC preamble sequence A 455 to determine the actual timing adjustment demanded to align the time of the UE 115 with the network entity 105. For example, the line 465 shows the autocorrelation calculated by the network entity 105 between the ZC preamble sequence A 455 (e.g., received in the MSG1 220 as described with reference to FIG. 2) and the same ZC preamble sequence 460 at other times. For example, as shown in the preamble sequence correlation-time graph 400, the autocorrelation output of the ZC preamble sequence A 455 received by the network entity 105 and the ZC preamble sequence 460-a at an earlier time is low, the autocorrelation output of the ZC preamble sequence A 455 and the ZC preamble sequence 460-c at a later time is low, and the autocorrelation output of the ZC preamble sequence A 455 and the ZC preamble sequence 460-b at the same time is high. Accordingly, the network entity 105 may identify the timing of the ZC preamble sequence A 455 received by the network entity 105 by determining a peak in the autocorrelation output, which timing may be used to determine the timing advance indicated in the MSG2 230. Similarly, the network entity 105 may determine the sequence used by using the cross-correlation properties of the ZC preamble sequence A 455. For example, the cross-correlation of the ZC preamble sequence A 455 and the ZC preamble sequence B 470 (different from the ZC preamble sequence A 455) may be low.

The network entity 105 may expect, and may receive, the second preamble 425 a period of time 410 after reception of the first preamble 420. The sequence of the second preamble 425 may be based on the sequence of the first preamble 420 (e.g., may be based on the ZC preamble sequence A 455). Accordingly, autocorrelation of the sequence of the second preamble 425 and the first preamble 420 may result in a value other than “1” (e.g., perfect autocorrelation) or “0” (e.g., other than perfect cross-correlation). For example, the if ZC preamble sequence A 455 is used for the first preamble 420, the second sequence 475 of the second preamble 425 may be given by (A XOR (A XOR X1)), and the network entity 105 may use an XOR operation to extract X1 (e.g., the identifier of the UE 115 that transmitted the first preamble 420 and the second preamble 425) from the second sequence 475. The network entity 105 may correlate the extracted ID to an establishment cause or sub-classification within a vertical as described herein.

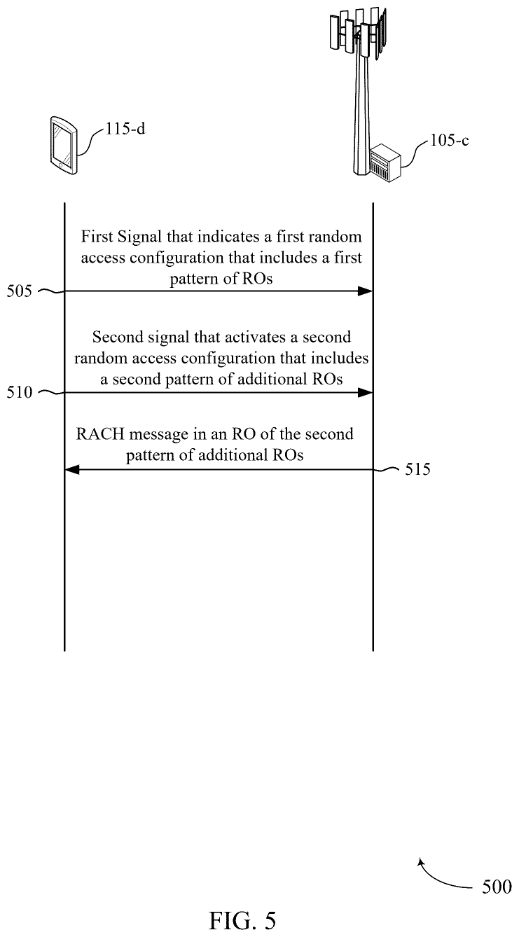

FIG. 5 shows an example of a process flow 500 that supports RACH preamble techniques in accordance with one or more aspects of the present disclosure. The process flow 500 may implement or may be implemented by aspects of the wireless communications system 100, the timing diagram 200, the preamble sequence correlation-time graph 250, the preamble sequence correlation-time graph 400, or the wireless communications system 300. For example, the process flow 500 may include a UE 115-d, which may be an example of a UE 115 as described herein. The process flow 500 may also include a network entity 105-c, which may be an example of a network entity 105 as described herein. In the following description of the process flow 500, the communications between the network entity 105-c and the UE 115-d may be transmitted in a different order than the example order shown, or the operations performed by the network entity 105-c and the UE 115-d may be performed in different orders or at different times. Some operations may also be omitted from the process flow 500, and other operations may be added to the process flow 500.

At 505, the UE 115-d may transmit, and the network entity 105-c may receive, within an RO, a first preamble that uses a first sequence from a set of multiple candidate sequences.

At 510, the UE 115-d may transmit, and the network entity 105-c may receive, within the same RO and after transmission of the first preamble, a second preamble that is based on the first sequence. The second preamble may be indicative of an identifier associated with the UE 115-d.

At 515, the UE 115-d may receive, from the network entity 105-c, a response message based on the first preamble and the second preamble.

In some examples, the second preamble is based on the first sequence via using a second sequence that is an XOR operation of the first sequence and the identifier (e.g., where the first sequence is A and the identifier is X1, the second sequence may be given by A XOR (A XOR X1)).

In some examples, the second preamble may be indicative of the identifier of the UE based on a duration between transmission of the first preamble and the second preamble. In some examples, the second preamble uses the first sequence (e.g., the second preamble may use the same sequence as the first preamble).

In some examples, the identifier may be indicative of a RACH establishment cause associated with the first preamble and the second preamble.

In some examples, the identifier may be indicative of a device type of the UE 115-d (such as a regular UE, a RedCap UE, an ambient IoT device, or a UE that performs SDT).

In some examples, the identifier may be indicative of a priority associated with the UE 115-d (e.g., associated with a purpose of the RACH procedure, such as an emergency communication, a high priority communication, or a regular priority communication).

In some examples, a duration between transmission of the first preamble and the second preamble may be based on a RO periodicity, a cell dimension associated with the RO, or a combination thereof.

In some examples, the network entity 105-c may transmit, and the UE 115-d may receive, SI that indicates a duration between subsequent preambles within a same RO, and transmission of the second preamble may be in accordance with the duration indicated by the SI.

In some examples, the network entity 105-c may transmit, and the UE 115-d may receive, control signaling addressed to the UE 115-d that indicates a duration between subsequent preambles within a same RO, and transmission of the second preamble may in accordance with the duration indicated by the control signaling.

In some examples, the UE 115-d may transmit, and the network entity 105-c may receive, a third preamble in a second RO after the RO in accordance with backoff information indicated in the response message. In some such examples, the network entity 105-c may receive, from a second UE 115 and within the RO, a third preamble that uses the first sequence. In such examples, the network entity 105-c may receive, from the second UE 115 and within the RO, a fourth preamble that is based on the first sequence, where the second preamble is indicative of a second identifier associated with the second UE 115. In such examples, the network entity 105-c may transmit, to the second UE 115, a grant that indicates a resource for a random access message based on the identifier and the second identifier, where inclusion of the backoff information in the response message is based on the identifier and the second identifier. For example, the network entity 105-c may prioritize the second UE 115 over the UE 115-d based on the identifier and the second identifier.

In some examples, the UE 115-d may transmit, and the network entity 105-c may receive, a RACH message (e.g., a MSG3) in a resource indicated in a grant provided by the response message. In some such examples, the network entity 105-c may receive, from a second UE 115 and within the RO, a third preamble that uses the first sequence. In such examples, the network entity 105-c may receive, from the second UE 115 and within the RO, a fourth preamble that is based on the first sequence, where the second preamble is indicative of a second identifier associated with the second UE, and where inclusion of the grant in the response message is based on the identifier and the second identifier. For example, the network entity 105-c may prioritize the UE 115-d over the second UE 115 based on the identifier and the second identifier. For example, the network entity 105-c may transmit a backoff indication to the second UE 115.

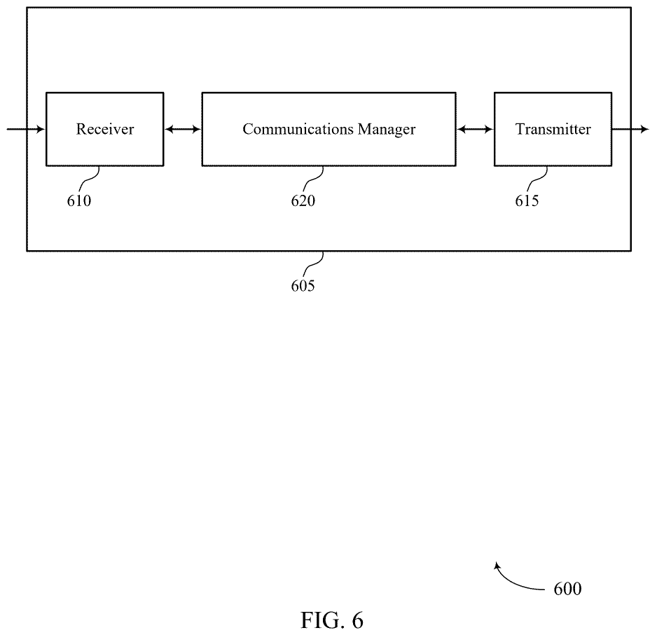

FIG. 6 shows a block diagram 600 of a device 605 that supports RACH preamble techniques in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to RACH preamble techniques). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RACH preamble techniques). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of RACH preamble techniques as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, within a RO, a first preamble that uses a first sequence from a set of multiple candidate sequences. The communications manager 620 is capable of, configured to, or operable to support a means for transmitting, within the RO and after transmission of the first preamble, a second preamble that is based on the first sequence, where the second preamble is indicative of an identifier associated with the UE. The communications manager 620 is capable of, configured to, or operable to support a means for receiving a response message based on the first preamble and the second preamble.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

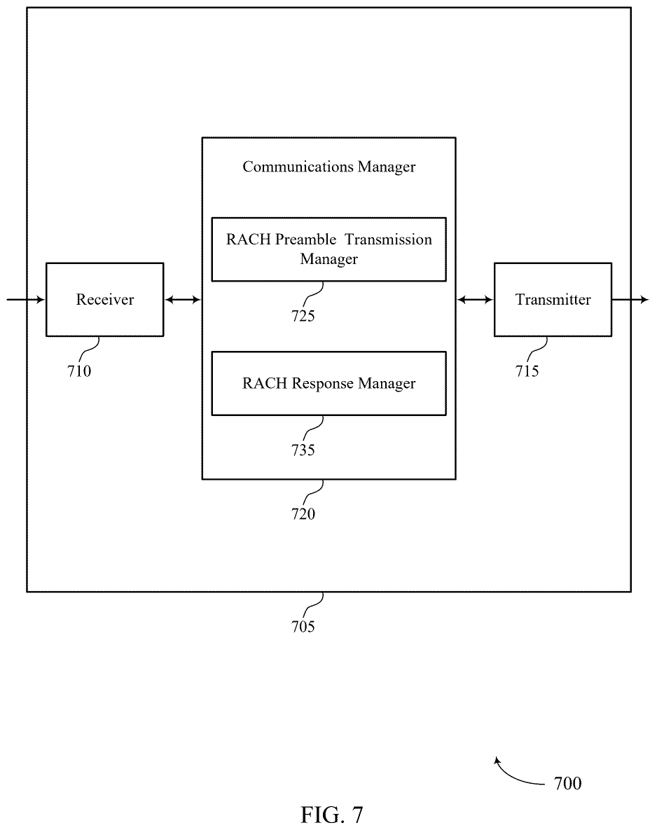

FIG. 7 shows a block diagram 700 of a device 705 that supports RACH preamble techniques in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to RACH preamble techniques). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RACH preamble techniques). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RACH preamble techniques as described herein. For example, the communications manager 720 may include a RACH preamble transmission manager 725, a RACH response manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The RACH preamble transmission manager 725 is capable of, configured to, or operable to support a means for transmitting, within a RO, a first preamble that uses a first sequence from a set of multiple candidate sequences. The RACH preamble transmission manager 725 is capable of, configured to, or operable to support a means for transmitting, within the RO and after transmission of the first preamble, a second preamble that is based on the first sequence, where the second preamble is indicative of an identifier associated with the UE. The RACH response manager 735 is capable of, configured to, or operable to support a means for receiving a response message based on the first preamble and the second preamble.

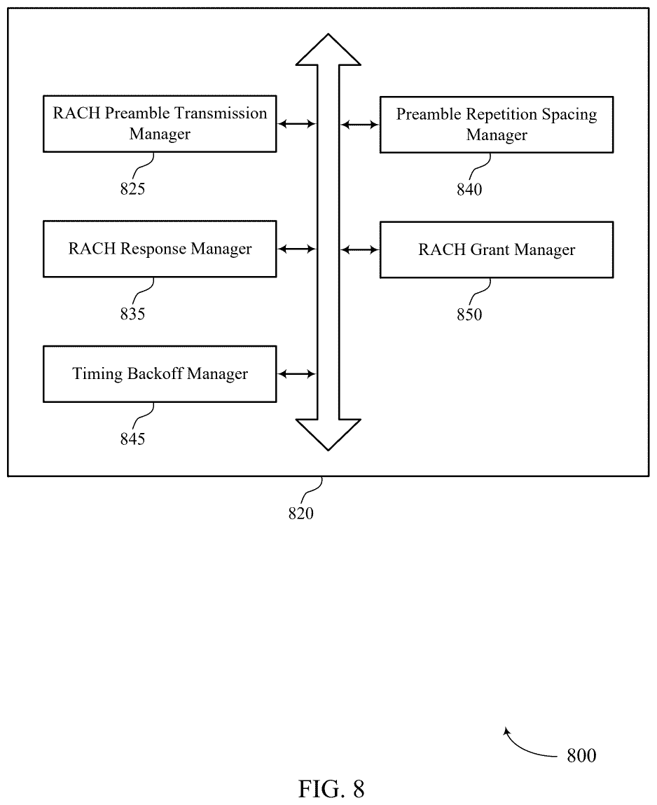

FIG. 8 shows a block diagram 800 of a communications manager 820 that supports RACH preamble techniques in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RACH preamble techniques as described herein. For example, the communications manager 820 may include a RACH preamble transmission manager 825, a RACH response manager 835, a preamble repetition spacing manager 840, a timing backoff manager 845, a RACH grant manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The RACH preamble transmission manager 825 is capable of, configured to, or operable to support a means for transmitting, within a RO, a first preamble that uses a first sequence from a set of multiple candidate sequences. The RACH preamble transmission manager 825 is capable of, configured to, or operable to support a means for transmitting, within the RO and after transmission of the first preamble, a second preamble that is based on the first sequence, where the second preamble is indicative of an identifier associated with the UE. The RACH response manager 835 is capable of, configured to, or operable to support a means for receiving a response message based on the first preamble and the second preamble.

In some examples, the second preamble is based on the first sequence via using a second sequence that is an XOR operation of the first sequence and the identifier.

In some examples, the second preamble is indicative of the identifier of the UE based on a duration between transmission of the first preamble and the second preamble.

In some examples, the second preamble uses the first sequence.

In some examples, the identifier is indicative of a RACH establishment cause associated with the first preamble and the second preamble.

In some examples, the identifier is indicative of a device type of the UE.

In some examples, the identifier is indicative of a priority associated with the UE.

In some examples, a duration between transmission of the first preamble and the second preamble is based on a RO periodicity, a cell dimension associated with the RO, or a combination thereof.

In some examples, the preamble repetition spacing manager 840 is capable of, configured to, or operable to support a means for receiving SI that indicates a duration between subsequent preambles within a same RO, where transmission of the second preamble is in accordance with the duration.

In some examples, the preamble repetition spacing manager 840 is capable of, configured to, or operable to support a means for receiving control signaling addressed to the UE that indicates a duration between subsequent preambles within a same RO, where transmission of the second preamble is in accordance with the duration.

In some examples, the timing backoff manager 845 is capable of, configured to, or operable to support a means for transmitting a third preamble in a second RO after the RO in accordance with backoff information indicated in the response message.

In some examples, the RACH grant manager 850 is capable of, configured to, or operable to support a means for transmitting a RACH message in a resource indicated in a grant provided by the response message.

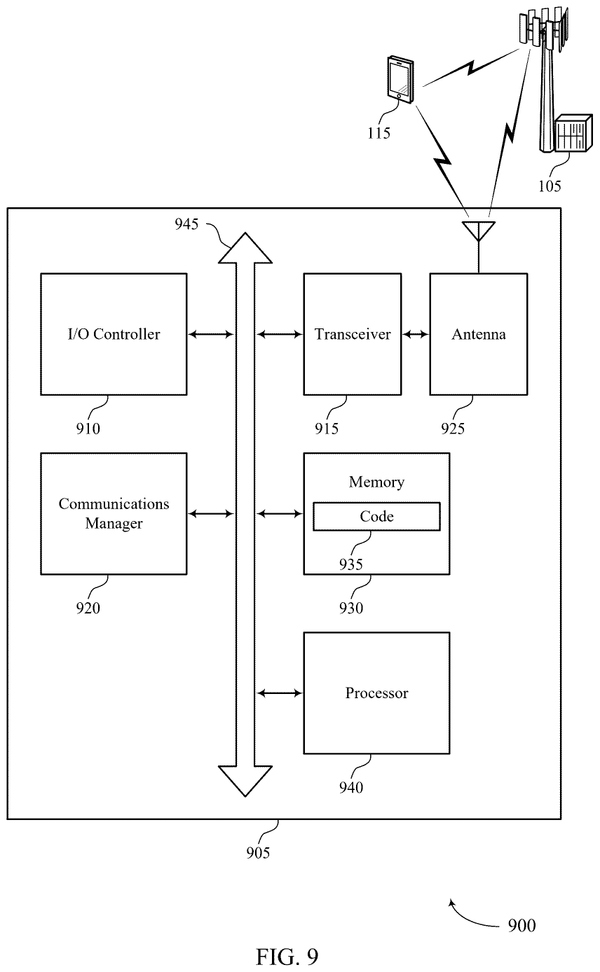

FIG. 9 shows a diagram of a system 900 including a device 905 that supports RACH preamble techniques in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting RACH preamble techniques). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, within a RO, a first preamble that uses a first sequence from a set of multiple candidate sequences. The communications manager 920 is capable of, configured to, or operable to support a means for transmitting, within the RO and after transmission of the first preamble, a second preamble that is based on the first sequence, where the second preamble is indicative of an identifier associated with the UE. The communications manager 920 is capable of, configured to, or operable to support a means for receiving a response message based on the first preamble and the second preamble.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of RACH preamble techniques as described herein, or the at least one processor 940 and the at least one memory 930 may be otherwise configured to, individually or collectively, perform or support such operations.

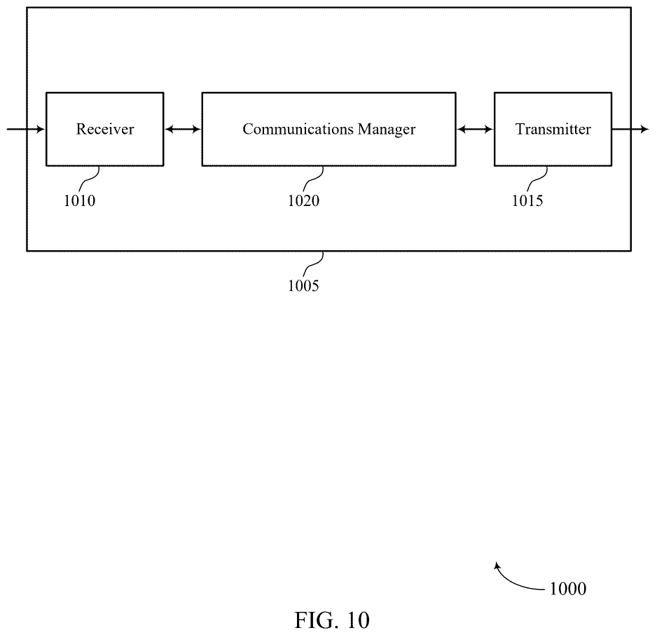

FIG. 10 shows a block diagram 1000 of a device 1005 that supports RACH preamble techniques in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of RACH preamble techniques as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving, from a UE and within a RO, a first preamble that uses a first sequence from a set of multiple candidate sequences. The communications manager 1020 is capable of, configured to, or operable to support a means for receiving, from the UE and within the RO and after transmission of the first preamble, a second preamble that is based on the first sequence, where the second preamble is indicative of an identifier associated with the UE. The communications manager 1020 is capable of, configured to, or operable to support a means for transmitting, to the UE, a response message based on the first preamble and the second preamble.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

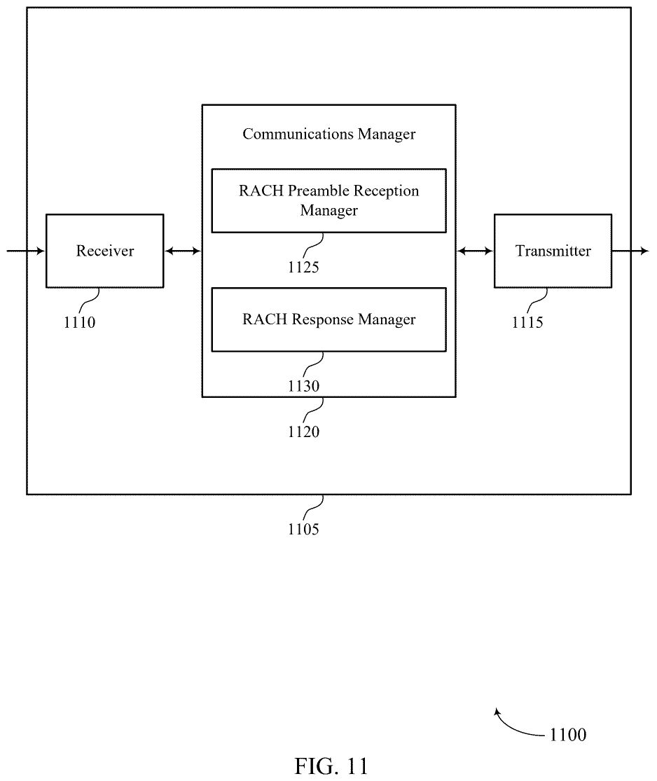

FIG. 11 shows a block diagram 1100 of a device 1105 that supports RACH preamble techniques in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of RACH preamble techniques as described herein. For example, the communications manager 1120 may include a RACH preamble reception manager 1125 a RACH response manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The RACH preamble reception manager 1125 is capable of, configured to, or operable to support a means for receiving, from a UE and within a RO, a first preamble that uses a first sequence from a set of multiple candidate sequences. The RACH preamble reception manager 1125 is capable of, configured to, or operable to support a means for receiving, from the UE and within the RO and after transmission of the first preamble, a second preamble that is based on the first sequence, where the second preamble is indicative of an identifier associated with the UE. The RACH response manager 1130 is capable of, configured to, or operable to support a means for transmitting, to the UE, a response message based on the first preamble and the second preamble.

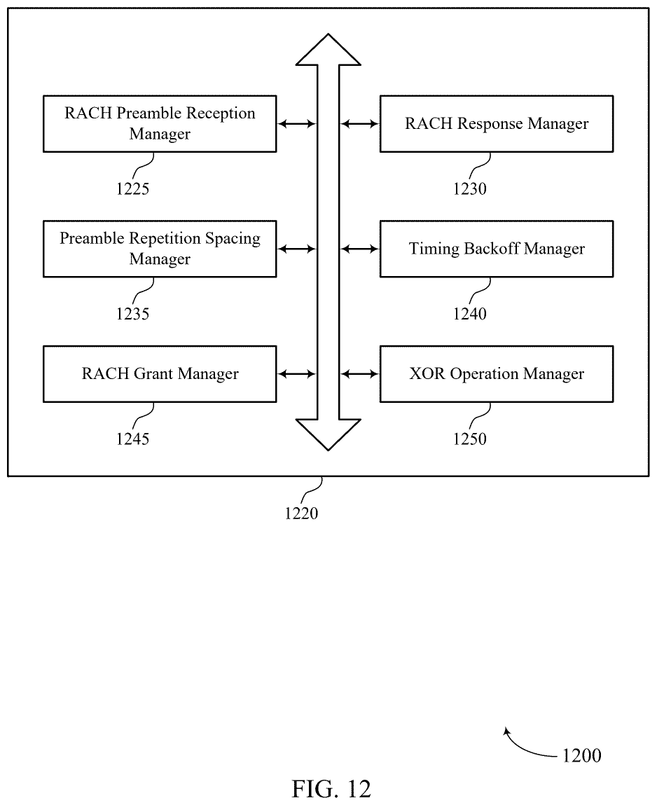

FIG. 12 shows a block diagram 1200 of a communications manager 1220 that supports RACH preamble techniques in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RACH preamble techniques as described herein. For example, the communications manager 1220 may include a RACH preamble reception manager 1225, a RACH response manager 1230, a preamble repetition spacing manager 1235, a timing backoff manager 1240, a RACH grant manager 1245, a XOR operation manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The RACH preamble reception manager 1225 is capable of, configured to, or operable to support a means for receiving, from a UE and within a RO, a first preamble that uses a first sequence from a set of multiple candidate sequences. In some examples, the RACH preamble reception manager 1225 is capable of, configured to, or operable to support a means for receiving, from the UE and within the RO and after transmission of the first preamble, a second preamble that is based on the first sequence, where the second preamble is indicative of an identifier associated with the UE. The RACH response manager 1230 is capable of, configured to, or operable to support a means for transmitting, to the UE, a response message based on the first preamble and the second preamble.

In some examples, the second preamble is based on the first sequence via using a second sequence that is an XOR operation of the first sequence and the identifier.

In some examples, the XOR operation manager 1250 is capable of, configured to, or operable to support a means for performing an XOR operation on the first sequence and the second sequence to extract the identifier from the second sequence.

In some examples, the second preamble is indicative of the identifier of the UE based on a duration between transmission of the first preamble and the second preamble.

In some examples, the second preamble uses the first sequence.

In some examples, the identifier is indicative of a RACH establishment cause associated with the first preamble and the second preamble.

In some examples, the identifier is indicative of a device type of the UE.

In some examples, the identifier is indicative of a priority associated with the UE.

In some examples, a duration between transmission of the first preamble and the second preamble is based on a RO periodicity, a cell dimension associated with the RO, or a combination thereof.

In some examples, the preamble repetition spacing manager 1235 is capable of, configured to, or operable to support a means for transmitting SI that indicates a duration between subsequent preambles within a same RO, where reception of the second preamble is in accordance with the duration.

In some examples, the preamble repetition spacing manager 1235 is capable of, configured to, or operable to support a means for transmitting control signaling addressed to the UE that indicates a duration between subsequent preambles within a same RO, where reception of the second preamble is in accordance with the duration.

In some examples, the timing backoff manager 1240 is capable of, configured to, or operable to support a means for receiving a third preamble in a second RO after the RO in accordance with backoff information indicated in the response message.

In some examples, the RACH preamble reception manager 1225 is capable of, configured to, or operable to support a means for receiving, from a second UE and within the RO, a third preamble that uses the first sequence. In some examples, the RACH preamble reception manager 1225 is capable of, configured to, or operable to support a means for receiving, from the second UE and within the RO, a fourth preamble that is based on the first sequence, where the second preamble is indicative of a second identifier associated with the second UE. In some examples, the RACH response manager 1230 is capable of, configured to, or operable to support a means for transmitting, to the second UE, a grant that indicates a resource for a random access message based on the identifier and the second identifier, where inclusion of the backoff information in the response message is based on the identifier and the second identifier.

In some examples, the RACH grant manager 1245 is capable of, configured to, or operable to support a means for receiving, from the UE, a RACH message in a resource indicated in a grant provided by the response message.

In some examples, the RACH preamble reception manager 1225 is capable of, configured to, or operable to support a means for receiving, from a second UE and within the RO, a third preamble that uses the first sequence. In some examples, the RACH preamble reception manager 1225 is capable of, configured to, or operable to support a means for receiving, from the second UE and within the RO, a fourth preamble that is based on the first sequence, where the second preamble is indicative of a second identifier associated with the second UE, where inclusion of the grant in the response message is based on the identifier and the second identifier.

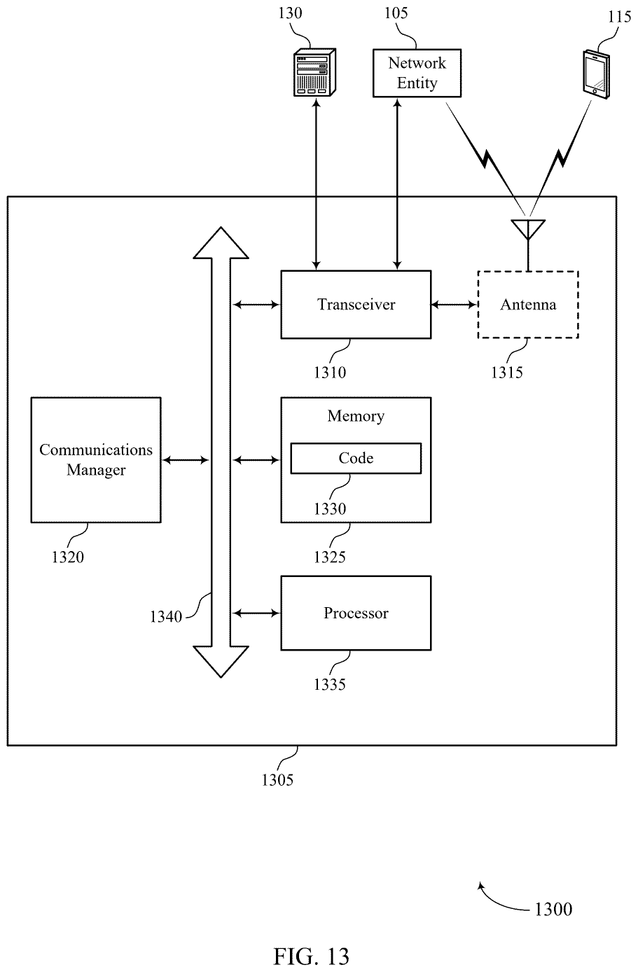

FIG. 13 shows a diagram of a system 1300 including a device 1305 that supports RACH preamble techniques in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting RACH preamble techniques). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for receiving, from a UE and within a RO, a first preamble that uses a first sequence from a set of multiple candidate sequences. The communications manager 1320 is capable of, configured to, or operable to support a means for receiving, from the UE and within the RO and after transmission of the first preamble, a second preamble that is based on the first sequence, where the second preamble is indicative of an identifier associated with the UE. The communications manager 1320 is capable of, configured to, or operable to support a means for transmitting, to the UE, a response message based on the first preamble and the second preamble.

By including or configuring the communications manager 1320 in accordance with examples as described herein, the device 1305 may support techniques for improved communication reliability, reduced latency, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of RACH preamble techniques as described herein, or the at least one processor 1335 and the at least one memory 1325 may be otherwise configured to, individually or collectively, perform or support such operations.

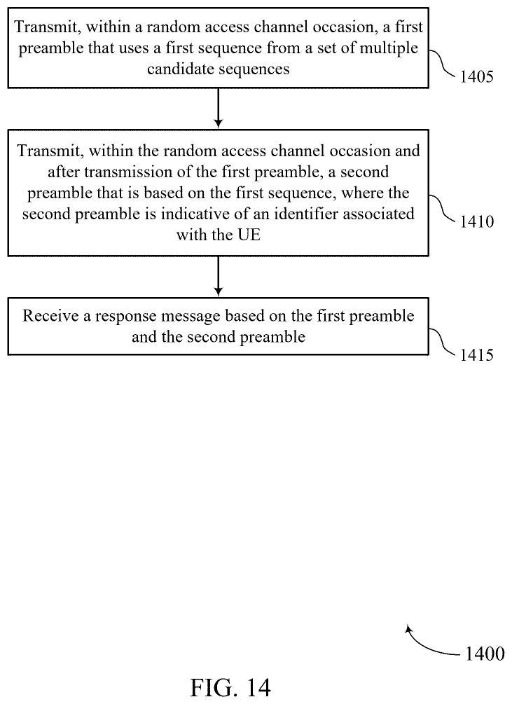

FIG. 14 shows a flowchart illustrating a method 1400 that supports RACH preamble techniques in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, within a RO, a first preamble that uses a first sequence from a set of multiple candidate sequences. The operations of 1405 may be performed in accordance with examples as disclosed herein. In some examples, aspects of the operations of 1405 may be performed by a RACH preamble transmission manager 825 as described with reference to FIG. 8.

At 1410, the method may include transmitting, within the RO and after transmission of the first preamble, a second preamble that is based on the first sequence, where the second preamble is indicative of an identifier associated with the UE. The operations of 1410 may be performed in accordance with examples as disclosed herein. In some examples, aspects of the operations of 1410 may be performed by a RACH preamble transmission manager 825 as described with reference to FIG. 8.

At 1415, the method may include receiving a response message based on the first preamble and the second preamble. The operations of 1415 may be performed in accordance with examples as disclosed herein. In some examples, aspects of the operations of 1415 may be performed by a RACH response manager 835 as described with reference to FIG. 8.

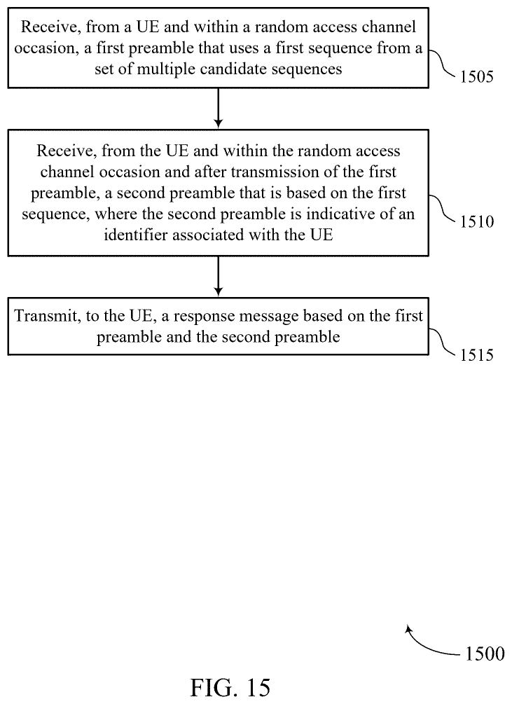

FIG. 15 shows a flowchart illustrating a method 1500 that supports RACH preamble techniques in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE and within a RO, a first preamble that uses a first sequence from a set of multiple candidate sequences. The operations of 1505 may be performed in accordance with examples as disclosed herein. In some examples, aspects of the operations of 1505 may be performed by a RACH preamble reception manager 1225 as described with reference to FIG. 12.

At 1510, the method may include receiving, from the UE and within the RO and after transmission of the first preamble, a second preamble that is based on the first sequence, where the second preamble is indicative of an identifier associated with the UE. The operations of 1510 may be performed in accordance with examples as disclosed herein. In some examples, aspects of the operations of 1510 may be performed by a RACH preamble reception manager 1225 as described with reference to FIG. 12.

At 1515, the method may include transmitting, to the UE, a response message based on the first preamble and the second preamble. The operations of 1515 may be performed in accordance with examples as disclosed herein. In some examples, aspects of the operations of 1515 may be performed by a RACH response manager 1230 as described with reference to FIG. 12.

The following provides an overview of aspects of the present disclosure:

Aspect 1: A method for wireless communications at a UE, comprising: transmitting, within a RACH occasion, a first preamble that uses a first sequence from a plurality of candidate sequences; transmitting, within the RACH occasion and after transmission of the first preamble, a second preamble that is based at least in part on the first sequence, wherein the second preamble is indicative of an identifier associated with the UE; and receiving a response message based at least in part on the first preamble and the second preamble.

Aspect 2: The method of aspect 1, wherein the second preamble is based at least in part on the first sequence via using a second sequence that is an XOR operation of the first sequence and the identifier.

Aspect 3: The method of any of aspects 1 through 2, wherein the second preamble is indicative of the identifier of the UE based at least in part on a duration between transmission of the first preamble and the second preamble.

Aspect 4: The method of aspect 3, wherein the second preamble uses the first sequence.

Aspect 5: The method of any of aspects 1 through 4, wherein the identifier is indicative of a RACH establishment cause associated with the first preamble and the second preamble.

Aspect 6: The method of any of aspects 1 through 5, wherein the identifier is indicative of a device type of the UE.

Aspect 7: The method of any of aspects 1 through 6, wherein the identifier is indicative of a priority associated with the UE.

Aspect 8: The method of any of aspects 1 through 7, wherein a duration between transmission of the first preamble and the second preamble is based at least in part on a RACH occasion periodicity, a cell dimension associated with the RACH occasion, or a combination thereof.

Aspect 9: The method of any of aspects 1 through 8, further comprising: receiving SI that indicates a duration between subsequent preambles within a same RACH occasion, wherein transmission of the second preamble is in accordance with the duration.

Aspect 10: The method of any of aspects 1 through 8, further comprising: receiving control signaling addressed to the UE that indicates a duration between subsequent preambles within a same RACH occasion, wherein transmission of the second preamble is in accordance with the duration.

Aspect 11: The method of any of aspects 1 through 10, further comprising: transmitting a third preamble in a second RACH occasion after the RACH occasion in accordance with backoff information indicated in the response message.

Aspect 12: The method of any of aspects 1 through 10, further comprising: transmitting a RACH message in a resource indicated in a grant provided by the response message.

Aspect 13: A method for wireless communications at a network entity, comprising: receiving, from a UE and within a RACH occasion, a first preamble that uses a first sequence from a plurality of candidate sequences; receiving, from the UE and within the RACH occasion and after transmission of the first preamble, a second preamble that is based at least in part on the first sequence, wherein the second preamble is indicative of an identifier associated with the UE; and transmitting, to the UE, a response message based at least in part on the first preamble and the second preamble.

Aspect 14: The method of aspect 13, wherein the second preamble is based at least in part on the first sequence via using a second sequence that is an XOR operation of the first sequence and the identifier.

Aspect 15: The method of aspect 14, further comprising: performing an XOR operation on the first sequence and the second sequence to extract the identifier from the second sequence.

Aspect 16: The method of any of aspects 13 through 15, wherein the second preamble is indicative of the identifier of the UE based at least in part on a duration between transmission of the first preamble and the second preamble.

Aspect 17: The method of aspect 16, wherein the second preamble uses the first sequence.

Aspect 18: The method of any of aspects 13 through 17, wherein the identifier is indicative of a RACH establishment cause associated with the first preamble and the second preamble.

Aspect 19: The method of any of aspects 13 through 18, wherein the identifier is indicative of a device type of the UE.

Aspect 20: The method of any of aspects 13 through 19, wherein the identifier is indicative of a priority associated with the UE.

Aspect 21: The method of any of aspects 13 through 20, wherein a duration between transmission of the first preamble and the second preamble is based at least in part on a RACH occasion periodicity, a cell dimension associated with the RACH occasion, or a combination thereof.

Aspect 22: The method of any of aspects 13 through 21, further comprising: transmitting SI that indicates a duration between subsequent preambles within a same RACH occasion, wherein reception of the second preamble is in accordance with the duration.

Aspect 23: The method of any of aspects 13 through 21, further comprising: transmitting control signaling addressed to the UE that indicates a duration between subsequent preambles within a same RACH occasion, wherein reception of the second preamble is in accordance with the duration.

Aspect 24: The method of any of aspects 13 through 23, further comprising: receiving a third preamble in a second RACH occasion after the RACH occasion in accordance with backoff information indicated in the response message.

Aspect 25: The method of aspect 24, further comprising: receiving, from a second UE and within the RACH occasion, a third preamble that uses the first sequence; and receiving, from the second UE and within the RACH occasion, a fourth preamble that is based at least in part on the first sequence, wherein the second preamble is indicative of a second identifier associated with the second UE; and transmitting, to the second UE, a grant that indicates a resource for a random access message based at least in part on the identifier and the second identifier, wherein inclusion of the backoff information in the response message is based at least in part on the identifier and the second identifier.

Aspect 26: The method of any of aspects 13 through 23, further comprising: receiving, from the UE, a RACH message in a resource indicated in a grant provided by the response message.

Aspect 27: The method of aspect 26, further comprising: receiving, from a second UE and within the RACH occasion, a third preamble that uses the first sequence; and receiving, from the second UE and within the RACH occasion, a fourth preamble that is based at least in part on the first sequence, wherein the second preamble is indicative of a second identifier associated with the second UE, wherein inclusion of the grant in the response message is based at least in part on the identifier and the second identifier.

Aspect 28: A UE for wireless communications, comprising one or more memories storing processor-executable code, and one or more processors coupled with the one or more memories and individually or collectively operable to execute the code to cause the UE to perform a method of any of aspects 1 through 12.

Aspect 29: A UE for wireless communications, comprising at least one means for performing a method of any of aspects 1 through 12.

Aspect 30: A non-transitory computer-readable medium storing code for wireless communications, the code comprising instructions executable by one or more processors to perform a method of any of aspects 1 through 12.

Aspect 31: A network entity for wireless communications, comprising one or more memories storing processor-executable code, and one or more processors coupled with the one or more memories and individually or collectively operable to execute the code to cause the network entity to perform a method of any of aspects 13 through 27.

Aspect 32: A network entity for wireless communications, comprising at least one means for performing a method of any of aspects 13 through 27.

Aspect 33: A non-transitory computer-readable medium storing code for wireless communications, the code comprising instructions executable by one or more processors to perform a method of any of aspects 13 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, within a random access channel occasion, a first preamble that uses a first sequence from a plurality of candidate sequences;
transmit, within the random access channel occasion and after transmission of the first preamble, a second preamble that is based at least in part on the first sequence, wherein the second preamble is indicative of an identifier associated with the UE; and
receive a response message based at least in part on the first preamble and the second preamble.

2. The UE of claim 1, wherein the second preamble is based at least in part on the first sequence via using a second sequence that is an XOR operation of the first sequence and the identifier.

3. The UE of claim 1, wherein the second preamble is indicative of the identifier of the UE based at least in part on a duration between transmission of the first preamble and the second preamble.

4. The UE of claim 3, wherein the second preamble uses the first sequence.

5. The UE of claim 1, wherein the identifier is indicative of a random access channel establishment cause associated with the first preamble and the second preamble.

6. The UE of claim 1, wherein the identifier is indicative of a device type of the UE.

7. The UE of claim 1, wherein the identifier is indicative of a priority associated with the UE.

8. The UE of claim 1, wherein a duration between transmission of the first preamble and the second preamble is based at least in part on a random access channel occasion periodicity, a cell dimension associated with the random access channel occasion, or a combination thereof.

9. The UE of claim 1, wherein the one or more processors are individually or collectively further operable to execute the code to cause the UE to:
receive system information that indicates a duration between subsequent preambles within a same random access channel occasion, wherein transmission of the second preamble is in accordance with the duration.

10. The UE of claim 1, wherein the one or more processors are individually or collectively further operable to execute the code to cause the UE to:
receive control signaling addressed to the UE that indicates a duration between subsequent preambles within a same random access channel occasion, wherein transmission of the second preamble is in accordance with the duration.

11. The UE of claim 1, wherein the one or more processors are individually or collectively further operable to execute the code to cause the UE to:
transmit a third preamble in a second random access channel occasion after the random access channel occasion in accordance with backoff information indicated in the response message.

12. The UE of claim 1, wherein the one or more processors are individually or collectively further operable to execute the code to cause the UE to:
transmit a random access channel message in a resource indicated in a grant provided by the response message.

13. A network entity, comprising:
one or more memories storing processor-executable code; and
one or more processors coupled with the one or more memories and individually or collectively operable to execute the code to cause the network entity to:
receive, from a user equipment (UE) and within a random access channel occasion, a first preamble that uses a first sequence from a plurality of candidate sequences;
receive, from the UE and within the random access channel occasion and after transmission of the first preamble, a second preamble that is based at least in part on the first sequence, wherein the second preamble is indicative of an identifier associated with the UE; and
transmit, to the UE, a response message based at least in part on the first preamble and the second preamble.

14. The network entity of claim 13, wherein the second preamble is based at least in part on the first sequence via using a second sequence that is an XOR operation of the first sequence and the identifier.

15. The network entity of claim 14, wherein the one or more processors are individually or collectively further operable to execute the code to cause the network entity to:
perform an XOR operation on the first sequence and the second sequence to extract the identifier from the second sequence.

16. The network entity of claim 13, wherein the second preamble is indicative of the identifier of the UE based at least in part on a duration between transmission of the first preamble and the second preamble.

17. The network entity of claim 16, wherein the second preamble uses the first sequence.

18. The network entity of claim 13, wherein the identifier is indicative of a random access channel establishment cause associated with the first preamble and the second preamble.

19. The network entity of claim 13, wherein the identifier is indicative of a device type of the UE.

20. The network entity of claim 13, wherein the identifier is indicative of a priority associated with the UE.

21. The network entity of claim 13, wherein a duration between transmission of the first preamble and the second preamble is based at least in part on a random access channel occasion periodicity, a cell dimension associated with the random access channel occasion, or a combination thereof.

22. The network entity of claim 13, wherein the one or more processors are individually or collectively further operable to execute the code to cause the network entity to:
transmit system information that indicates a duration between subsequent preambles within a same random access channel occasion, wherein reception of the second preamble is in accordance with the duration.

23. The network entity of claim 13, wherein the one or more processors are individually or collectively further operable to execute the code to cause the network entity to:
transmit control signaling addressed to the UE that indicates a duration between subsequent preambles within a same random access channel occasion, wherein reception of the second preamble is in accordance with the duration.

24. The network entity of claim 13, wherein the one or more processors are individually or collectively further operable to execute the code to cause the network entity to:
receive a third preamble in a second random access channel occasion after the random access channel occasion in accordance with backoff information indicated in the response message.

25. The network entity of claim 24, wherein the one or more processors are individually or collectively further operable to execute the code to cause the network entity to:
receive, from a second UE and within the random access channel occasion, a third preamble that uses the first sequence;
receive, from the second UE and within the random access channel occasion, a fourth preamble that is based at least in part on the first sequence, wherein the second preamble is indicative of a second identifier associated with the second UE; and
transmit, to the second UE, a grant that indicates a resource for a random access message based at least in part on the identifier and the second identifier, wherein inclusion of the backoff information in the response message is based at least in part on the identifier and the second identifier.

26. The network entity of claim 13, wherein the one or more processors are individually or collectively further operable to execute the code to cause the network entity to:
receive, from the UE, a random access channel message in a resource indicated in a grant provided by the response message.

27. The network entity of claim 26, wherein the one or more processors are individually or collectively further operable to execute the code to cause the network entity to:
receive, from a second UE and within the random access channel occasion, a third preamble that uses the first sequence; and
receive, from the second UE and within the random access channel occasion, a fourth preamble that is based at least in part on the first sequence, wherein the second preamble is indicative of a second identifier associated with the second UE, wherein inclusion of the grant in the response message is based at least in part on the identifier and the second identifier.

28. A method for wireless communications at a user equipment (UE), comprising:
transmitting, within a random access channel occasion, a first preamble that uses a first sequence from a plurality of candidate sequences;
transmitting, within the random access channel occasion and after transmission of the first preamble, a second preamble that is based at least in part on the first sequence, wherein the second preamble is indicative of an identifier associated with the UE; and
receiving a response message based at least in part on the first preamble and the second preamble.

29. The method of claim 28, wherein the second preamble is based at least in part on the first sequence via using a second sequence that is an XOR operation of the first sequence and the identifier.

30. A method for wireless communications at a network entity, comprising:
receiving, from a user equipment (UE) and within a random access channel occasion, a first preamble that uses a first sequence from a plurality of candidate sequences;
receiving, from the UE and within the random access channel occasion and after transmission of the first preamble, a second preamble that is based at least in part on the first sequence, wherein the second preamble is indicative of an identifier associated with the UE; and
transmitting, to the UE, a response message based at least in part on the first preamble and the second preamble.
